(19) United States
(12) Patent Application Publication
(10) Pub. No.: US 2007/0254634 A1
(43) Pub. Date: Nov. 1, 2007

(54) Configuring a local network device using a wireless provider network

(76) Inventors: Jose Costa-Requena, Helsinki (FI); Inmaculada Espigares, Helsinki (FI)

Correspondence Address: Hollingsworth & Funk, LLC, Suite 125, 8009 34th Avenue South, Minneapolis, MN, 55425, US

(21) Appl. No.: 11/412,700

(22) Filed: Apr. 27, 2006

(51) Int. Cl. H04L 12/58

(52) U.S. Cl. 455/412.1

(57) ABSTRACT

A configuration for a local network device is downloaded via a mobile device management service of a wireless provider network. The configuration is applied to the device via the local network, and the service is enabled via a mobile communications device in response to applying the configuration. In another arrangement, a configuration is downloaded to a control device of the local network from a service entity of a remote network. The configuration is applied, via the local network using the control device, to a gateway device that couples the local network with the remote network. The configuration is applied to a mobile communications device via the local network using the control device. The mobile communications device is then enabled to access the local network from the external network via the gateway device.

### FIELD OF THE INVENTION

This invention relates in general to computing devices, and more particularly to automatic configuration of computing devices via networks.

### BACKGROUND OF THE INVENTION

Mobile communications devices such as cell phones increasingly include advanced data processing and communications capabilities. Far from being simple voice communications tools, modern mobile devices may include many different capabilities, such as email, text messaging, Web browsing, digital photography, sound recording/playback, location awareness, etc. As such, these devices are gaining ever-wider acceptance and are become increasingly valuable to end-users.

In order to increase the bandwidth available to mobile device users, mobile network providers and mobile device manufacturers are transitioning to third-generation (3G) technologies. The designation 3G refers to a collection of standards and technologies that can be used in the near future to enhance performance and increase data speed on cell phone networks. In particular, 3G is an International Telecommunication Union (ITU) specification for the third generation of mobile communications technology. A 3G cell phone would, in theory, be compatible with the 3G languages or standards which support enhanced data speeds.

Besides communicating over provider networks, 3G devices may also be used to communicate locally with other consumer electronics devices in a user's home or workplace. For example, a standard known as Universal Plug and Play™ (UPnP) provides a way for disparate processing devices to exchange data via a home network. The UPnP specification includes standards for service discovery, and is mainly targeted for proximity or ad hoc networks. Various contributors publish UPnP device and service descriptions, thus creating a way to easily connect devices and simplifying the implementation of networks. It is the goal of UPnP to enable home electronics to seamlessly interact, thus furthering the usefulness of such devices. Because a 3G communications device can also process data, it is possible for such devices to communicate via UPNP networks.

Besides allowing locally connected to devices to intercommunicate, the UPnP standard provides a way for the locally devices to seamlessly access external networks such as the Internet. Generally, a UPNP Internet Gateway Device (IGD) resides on the edge of the UPNP network and provides connectivity to a Wide Area Network (WAN), including the Internet. An IGD may be implemented as a standalone device or included in another UPNP device (e.g., a personal computer). Besides allowing local UPNP devices to access the Internet, the IGD may also be configured to allow the user to access devices on the UPNP network via the Internet when the user is away from the local network.

In order for a user to access an UPnP IGD via the Internet, the IGD must be specially configured to be Internet accessible. Internet-accessible services are typically provided from a server having a static, publicly-routable IP address. Most home user accounts will not have a static IP address, and therefore the traditional methods of providing service using a publicly accessible hostname/IP address may not work. Further, the user will want access via the Internet to be limited, as the UPnP network should only be accessible by the user and other entities authorized by the user. Thus, in order to provide secure services at a non-static IP address that are accessible via the Internet, the IGD will typically require special configuration.

In order for an IGD to provide Internet accessible services, it may require that the IGD connect or otherwise utilize intermediary network elements. Where the IGD has a publicly routable but dynamic IP address, the IGD may be able to register with a Dynamic DNS service that allows mapping hostnames to dynamically assigned IP addresses. However, even where Dynamic DNS may be used, other intermediary network elements may prevent direct connections to an IGD. For example, where the IGD is behind a Network Address Translator (NAT) firewall, the IGD may not be able to determine its Internet routable address, as it may be using a non-routable address provided by the NAT. Further, the NAT may block incoming TCP/IP connections and certain UDP/IP datagrams, thus preventing easy access to the IGD via the Internet. There are ways to get around NATs in order to provide Internet services. For example, a relay server may be configured to maintain connections with an IGD and receive requests targeted for the IGD. The relay server may be able to perform authentication checks on the connection requests and forward the requests and other data to the IGD. Depending on the type of NAT, the IGD may also be able to accept incoming data over special UDP ports. The existence of the NAT and usable UDP ports can be determined by protocols such as Simple Traversal of User Datagram Protocol Through NATs (STUN).

Even though work-arounds may exist to provide remote services, the setup and maintenance of such services may be too complicated for the average home network users. Currently, the way to set up an IGD to operate in this manner is to manually enter the parameters via whatever interface is provided on the IGD device. However, this method is prone to error, and may be too complex for many users. In situations where the parameters are prone to change (e.g., a new IP address of a Dynamic DNS server, changing user passwords, etc.) a user would have to occasionally re-edit these parameters, which could be quite burdensome. Also, it may be difficult for the user to test the IGD settings after it is set up. Therefore, a way of seamlessly and automatically configuring an IGD to provide safe and reliable Internet access to a UPNP network is desirable.

### SUMMARY OF THE INVENTION

To overcome limitations in the prior art described above, and to overcome other limitations that will become apparent upon reading and understanding the present specification, the present invention discloses a system, apparatus and method for configuring a device capable of providing a service via a local network. In accordance with one embodiment of the invention, a method involves downloading a configuration for a device to the mobile communications device via a mobile device management service of a wireless provider network. The configuration is applied to the device via the local network using the mobile communications device. The service is enabled via the mobile communications device in response to applying the configuration.

In more particular embodiments, the device includes a gateway device that couples the local network with an external network, and enabling the service via the mobile communications device involves enabling the gateway to provide the service via the external network. The method may also involve testing the accessibility from the external network of the service via the gateway device from within the internal network. Testing the accessibility of the gateway device may involve detecting the presence of one or more Network Address Translators (NATs) coupled between the gateway device and the external network, and enabling the gateway device may involve configuring the gateway device to utilize a NAT traversal protocol. In other configurations, enabling the gateway device involves registering the gateway device with a network entity of the external network that assists the gateway device in receiving service requests via the external network. Registering the gateway device with a network entity of the external network may involve registering the gateway device with a relay server that receives the service requests via the external network on behalf of the gateway device and relays the requests to the gateway device. Registering the gateway device with a network entity of the external network may involve registering the gateway device with a Dynamic Domain Name Service.

In other, more particular embodiments, downloading the configuration via the mobile device management service involves downloading the configuration via an Open Mobile Alliance Device Management protocol. Applying the configuration to the device via the mobile communications device may involve applying the settings via a Universal Plug and Play service of the gateway device.

In another embodiment of the invention, a method for configuring access to a local network from an external network via a gateway device that couples the local network with the external network involves downloading a configuration to a control device of the local network from a service entity of the remote network. The configuration is applied to the gateway device via the local network using the control device. The configuration is also applied to a mobile communications device via the local network using the control device. The mobile communications device is enabled to access the local network from the external network via the gateway device in response to applying the configuration to the mobile communications device and the gateway device.

In another embodiment of the invention, a mobile terminal includes one or more network interfaces capable of communicating via a wireless provider network and a local network. A processor is coupled to the one or more network interfaces, and a memory is coupled to the processor. The memory includes instructions that cause the processor to download a configuration for a device of the local network via a mobile device management service of the wireless provider network, and apply the configuration to the device via the local network. The instructions cause the processor to enable a service of the device in response to applying the configuration, and access the service via the local network.

In more particular embodiments, the device of the local network comprises a gateway device that couples the local network to an external network, and the gateway device provides the service on behalf of a service element of the local network. The instructions may further cause the processor to test the accessibility of the service from the gateway device via the external network using a connection to the wireless provider network. The instructions may further cause the processor to, based on the configuration received via the mobile device management service, configure the mobile device to access the service from the gateway device via the external network. The configuration may include an Open Mobile Alliance Device Management configuration. The instructions may cause the processor to apply the configuration to the device via a Universal Plug and Play service of the device. The instructions may further cause the processor to, based on the configuration received via the mobile device management service, configure the mobile device to access the service via the local network.

In another embodiment of the invention, a gateway device includes a first network interface capable of communicating via a local network and a second network interface capable of communicating via an external network. A processor is coupled to the first and second network interfaces. A memory is coupled to the processor and includes a remote access module capable of providing access to a service of the local network via the external network. The memory further including instructions that cause the processor to receive a configuration via a mobile device coupled to the local network. The configuration originates from a mobile device management service accessible by the mobile device. The instructions cause the processor to apply the configuration to the remote access module and make the service accessible to the external network via the second network interface in response to applying the configuration to the remote access module.

In more particular embodiments, the instructions may further cause the processor to test the configuration of the remote access module by detecting the presence of one or more Network Address Translators (NATs) coupled between the gateway device and the external network, and make the service accessible to the external network by utilizing a NAT traversal protocol. The instructions may further cause the processor to register the gateway device with a network entity of the external network that assists the gateway device in receiving service requests. The network entity of the external network may include a relay server that receives the service requests via the external network on behalf of the gateway device and relays the requests to the gateway device, and/or a Dynamic Domain Name Service.

In another embodiment of the invention, a server arrangement includes a network interface capable of communicating via a public network and a wireless provider network. A processor is coupled to the network interface, and a memory is coupled to the processor. The memory includes a mobile device management service module and instructions that cause the processor to receive a request from a mobile device via the mobile device management service module. The request includes parameters of a service device of a local network that is capable of being accessed by the mobile device via the local network. The instructions cause the processor to form a configuration of the service device based on the parameters, and send a configuration of the device to the mobile device via the mobile device management service module for purposes of facilitating configuration of the service device by the mobile device via the local network.

In more particular embodiments, the service device of the local network includes a gateway device coupled to the local network and the public network, and the gateway device provides a service to the mobile device on behalf of a service element of the local network. The server arrangement may also include a network helper service module capable of allowing the gateway device to provide services accessible via the public network. The helper service module may include a relay service that accepts connection requests on behalf of the gateway device and relays the requests to the gateway device. The helper service module may include a Network Address Translator (NAT) traversal service that allows the gateway device to determine a publicly accessible network address usable by the gateway device for receiving requests. The helper service module may include a Dynamic Domain Name Service that maps a hostname to a dynamic address of the external network associated with the gateway device.

In another embodiment of the invention, a server arrangement includes a network interface capable of communicating via a public network. A processor is coupled to the network interface, and a memory is coupled to the processor. The memory includes instructions that cause the processor to receive a request from a control device coupled to a local network. The request includes a request for a configuration of a gateway device that couples the local network to the public network and a mobile device that is capable of being coupled to the local network and the public network. The instructions cause the processor to form the configuration based on parameters of the gateway device and mobile device contained in the request, and send the configuration to the control device for purposes of facilitating configuration of the gateway device and the mobile device. The configuration enables the mobile device to access the local network from the public network via the gateway device.

In another embodiment of the invention, a computer-readable medium has instructions stored thereon which are executable by a mobile terminal capable of being coupled to a local network and a wireless provider network. The instructions are executable for performing steps of: downloading a configuration for a device of the local network via a mobile device management service of the wireless provider network; applying the configuration to the device via the local network; enabling the service at the device via the local network; and accessing the service via the local network.

In another embodiment of the invention, a memory capable of storing data accessible by a mobile terminal via a mobile device management service of a wireless provider network includes a data structure stored in the memory. The data structure includes a mobile device configuration formatted for configuring the mobile terminal in accordance with the mobile device management service. The mobile device configuration includes data capable of configuring a device accessible by the mobile terminal via a local network. The local network is independent from the wireless provider network. The mobile device is capable of deriving a device configuration for the device based on the mobile device configuration, and communicating the device configuration to the device via the local network.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described representative examples of systems, apparatuses, and methods in accordance with the invention.

### BRIEF DESCRIPTION OF THE DRAWINGS

The invention is described in connection with the embodiments illustrated in the following diagrams.

FIG. 1 is a block diagram illustrating a system according to embodiments of the invention;

FIG. 2A is a block diagram illustrating the application of configuration data according to embodiments of the invention;

FIGS. 2B-D are block diagrams illustrating testing of configurations according to embodiments of the invention;

FIG. 3 is a block diagram of a mobile computing arrangement according to embodiments of the invention;

FIG. 4 is a block diagram of a gateway arrangement according to embodiments of the invention;

FIG. 5 is a block diagram of a network service arrangement according to embodiments of the invention;

FIG. 6 is a block diagram of a data structure and use thereof according to embodiments of the invention; and

FIG. 7 is a flowchart illustrating a configuration procedure according to embodiments of the invention; and

FIG. 8 is a flowchart illustrating configuring remote access using a UPnP control point according to an embodiment of the invention.

### DETAILED DESCRIPTION OF EMBODIMENTS OF THE INVENTION

In the following description of various exemplary embodiments, reference is made to the accompanying drawings that form a part hereof, and in which is shown by way of illustration various embodiments in which the invention may be practiced. It is to be understood that other embodiments may be utilized, as structural and operational changes may be made without departing from the scope of the present invention.

Generally, the present invention relates to using a mobile communications infrastructure for configuring devices of a local network. In one arrangement, the local network includes Universal Plug and Play (UPNP) compatible devices and services that are made accessible to via Internet via a UPnP Internet Gateway Device (IGD). A mobile device may be used to configure the IGD so that the IGD can provide services of the UPnP network to devices located outside of the local UPnP network. In order to provide this access, the IGD may require various specialized configurations to be applied. These configurations may be specific to the provider networks (e.g., cellular provider, Internet service provider, etc.) and may also involve third-party service providers (e.g., Dynamic DNS provider). The configurations may also enable the IGD to deal with intermediary elements such as proxies and NATs that could alter the way the IGD will present a particular service. After configuration, the user may use a mobile device such as a cellular phone to access the UPnP network remotely via the Internet.

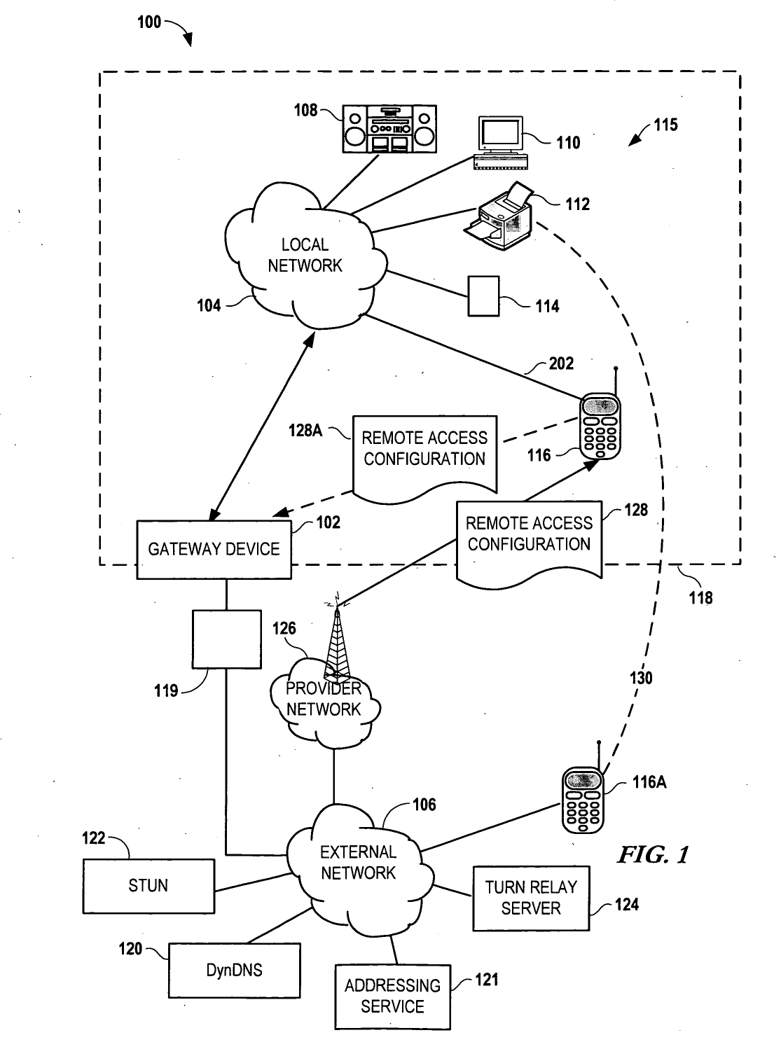

In reference now to FIG. 1, a block diagram 100 illustrates a system capable of configuring a gateway device 102 according to embodiments of the invention. The gateway device 102 is coupled to both a local network 104 and an external network 106. The gateway device 102 may perform any combination of functions, including that of a router, firewall, bridge, gateway, adapter, modem, wireless access point, or any other element that handles data transfers occurring between two or more network interfaces. In one configuration, the gateway device 102 includes the functionality of a UPnP IGD, and the local network 104 supports UPnP devices and services.

The local network 104 may include any combination of data transmission media and protocols. For example, the network may utilize wired or wireless data transmission media. Similarly, devices on the local network 104 may various physical and data link layer protocols to intercommunicate, including, Ethernet, FDDI, PPP, ATM, HDLC, Fibre Channel, X-10, serial/parallel point-to-point connections, etc. A number of higher layer network protocols may operate on the network 104 as well, including TCP/IP, UDP/IP, IPX, Appletalk, ICMP, ARP, SNMP, DNS, FTP, NetBEUI.

Generally, the local network 104 may support one or more protocols for ad-hoc, peer-to-peer service discovery and interoperability. One example of this type of protocol is the UPnP architecture. UPnP uses the Simple Service Discovery Protocol (SSDP) for service discovery, and is generally built on top of Internet Protocol (IP) based networks. Although concepts of the present invention may be described in terms of UPNP networks, those familiar with the applicable art will appreciate that these concepts may be applied to any manner of ad-hoc, peer-to-peer networking arrangement suitable for consumer oriented networks. For example, the present invention may also be any combination of home networking and control technologies such as Jini, Bluetooth, X-10, xAP, Rendezvous, HomeRF, IrDA, etc.

In the future, more and more consumer devices 115 will include processing capability, and therefore can benefit from being locally networked. In the illustrated diagram 100, the local network 104 couples an entertainment system 108, computer 110, printer 112, smart appliance 114, and mobile communications device 116 (e.g., cellular phone). These devices 108, 110, 112, 114, 116 are merely exemplary; any manner of electronic or electro-mechanical device may be made network-aware and interoperate via the local network 104. Protocols such as UPnP are designed to be generic and flexible so that any type of control or data processing functionality can be abstracted and offered as a service to any other UPnP capable entity on the network 104.

The local network 104 is typically designed to service a limited physical region, as indicated by the physical region 118. This region 118 may include any space where a user would like devices to easily interoperate, including a home, office, hotel room, automobile, airplane, boat, public wireless hotspot, etc. The protocols used in the local network 104 (e.g., UPnP) often assume that the network 104 will need to support only a limited number of devices operating within a reasonably small area. However, many devices on the local network 104 may benefit from information services available via the external network 106, particularly the Internet.

To provide access to the external network 106, one or more devices may be designated as the gateway device 102. The gateway device 102 may be designated as a default route for any traffic that is not routable on the local network 104. This traffic may include content such as Web pages, email, and protocols/services such as Domain Name Services (DNS), Windows Internet Naming Service (WINS), and Dynamic Host Configuration Protocol (DHCP). Generally, these types of content and services are utilized by clients operating on the local network 104 accessing a service on the external network 106. The gateway device 102, particularly a UPNP IGD, is typically capable of being easily configured either automatically or by the user to provide this type of access to the external network 106.

Although there are many advantages of interconnecting devices on the local network 104, it may be even more useful if the services and devices on the network 104 can be utilized from outside the environment 118, particularly via the external network 106. This form of access will be referred to herein as “remote access.” Generally remote access involves allowing devices on an external network 106 to access services and devices of a protected, local network 104. Remote access would typically provided by an entry point on that joins the two networks 104, 106, such as the gateway device 102.

In order for the gateway device 102 to provide remote access services from the local network 104, specialized provisions must typically be made at the gateway device 102. This is because the nature of the local network 104 is such that many consumer networks tend to share a single publicly routable address via the gateway device 102. This is commonly done using NAT, and the NAT may be built into the gateway device 102 itself, or be in another local or external intermediary, such as intermediary device 119. A NAT will create and maintain mappings between addresses and ports of the local network 104 and addresses and ports of the external network 106. Because the NAT will often only have a single address on the public network, the NAT will reassign TCP and UDP ports on the external side of the connection when connecting to external hosts. When receiving return data from the external network 106, the NAT will lookup the TCP/UDP port number of the incoming data and determine which IP address and port on the internal network 104 for which the data is destined. The NAT will change this value in the IDP/IP or TCP/IP headers, and forward the incoming data to the local network 104.

Because a NAT often uses only a single address on the external network 106, this may create problems in offering services originating on the local network 104. For example, if a host on the internal network 104 wants to act as an HTTP server, it will listen on TCP port 80. However, in order for this service to be available on the external network 106, the NAT will also need to listen on port 80, and be preconfigured to send all incoming connection requests on port 80 to the internal address of the host. This type of setup of the NAT may be complex, inflexible, and/or beyond the end-user's control. Also, ISPs may discourage customers from running network services on publicly addressable devices, because of both security and bandwidth usage concerns. Finally, this method of direct-mapping of ports by the NAT prevents more than one host on the internal network from using a particular TCP port on the external network 106.

Another problem involved in hosting a service from the gateway 102 and/or NAT of the internal network 104 is that the external network address of the gateway/NAT 102, 119 may be dynamically provided. In some cases, Internet Service Providers (ISPs) may have fewer allocable IP address than they have clients. In other cases, the ISP may simply want to avail themselves of the flexibility of inherent with dynamic address allocation. Therefore, the ISP may utilize DHCP or a similar protocol to allocate IP address on an as-needed basis. Most DNS services assume that IP addresses are static, and updates to DNS services are necessarily restricted to prevent domain hijacking and other malevolent activity. Therefore it often requires time and effort to update an IP address at the applicable authoritative DNS server.

In order to overcome these problems, various entities of the external network 106 can assist the gateway device 102 in providing internal network services to the external network 106. For example, where the gateway device 102 has a publicly accessible address that is dynamically allocated, the gateway 102 may be enabled to register the IP address and a predetermined hostname with a Dynamic DNS server 120 or other addressing server 121. Thereafter, any device that attempts to connect to a service of the local network 104 will perform a lookup on the Dynamic DNS server 120 in order to determine the address of the gateway device 102 on the external network 106.

Assuming the gateway device 102 has a publicly-routable IP address on its external (WAN) interface, then gateway initially registers with the Dynamic DNS server 120, and thereafter updates the Dynamic DNS entries if the external IP address changes. If, however, the gateway device 102 determines that its external address is not publicly-routable (e.g., an address on a 10.0.0.0 network is not routable on the Internet), then the gateway device 102 may need to perform additional steps to determine an Internet routable address. Usually, a non-routable IP address indicates that the gateway device 102 is behind a NAT. One purpose of a NAT is to allow multiple computers on an internal network to share a single, public, IP address. The NAT may also be configured as a firewall, and will thus block incoming connection requests without special configuration.

Where the gateway device 102 is operating behind a NAT or other intermediary network element 119, the gateway device 102 may communicate with a Simple Traversal of User Datagram Protocol Through NATs (STUN) server 122 in order to discover an public address from which the device 102 may be reached. As is described in IETF RFC 3489, STUN a protocol that allows network devices to determine whether they are located behind a NAT, and if so, what publicly accessible IP addresses and ports may be used to access the device behind the NAT. In order to use STUN, a client (e.g., the IGD 102) on the local network 104 requires the address of a publicly accessible STUN server 122 in order to send a specially crafted set of UDP packets to the server 122. Based on these exchanges, the client can determine the type of NAT (if any) that the client is located behind, and what ports (if any) that the client may use to accept incoming UDP packets.

Generally, STUN only allows a local network device to asynchronously receive incoming UDP datagrams, and does not support incoming TCP handshake requests. STUN has been used for such applications as Voice over IP (VoIP) to allow incoming connections to applications located on restricted access networks. However, it is also possible to use STUN in other application areas. In particular, STUN may allow the gateway device 102 to provide services of the local network 104 via the external network 106. For example, the local network services may utilize UDP exclusively, or use and adapted protocols for establishing a TCP connection based on the receipt of a UDP connection request.

Depending on the topological conditions of the networks 104, 106, STUN may not be usable by all gateway devices. An alternate solution, described in an IETF draft proposal, is known as Traversal Using Relay NAT (TURN). TURN involves the use of a TURN relay server 124 residing on an external network 106 (e.g., the public Internet) to relay data to a service operating behind a NAT. The NAT-firewalled device receives a publicly addressable IP address from the TURN server 124. TURN is effective regardless of the network topology existing between the firewalled device. However, TURN generally only allows a single connection to the firewalled server, and typically cannot be used to allow NAT firewalled servers to run Internet accessible services on well-known ports. It will be appreciated that STUN and TURN are merely examples of NAT traversal techniques and protocols. The present invention is independent of the actual traversal techniques used, an may be applied using any NAT traversal protocol, now known or later developed.

As described in greater detail above, it is typically straightforward to configure the gateway device 102 to act as a router on behalf of the local network 104 (e.g., to provide entities of the internal network 104 with access to the external network 106). Often such a configuration involves providing the gateway device 102 with addresses of a default route and a DNS server on the external network 106. These settings are typically static, and may be applied automatically by the ISP using a protocol such as DHCP. However, configuring the gateway device 102 to provide a service of the internal network 104 to entities of the external network 106 is more difficult. First, the configuration is dependent on the topology of the external network 106 and the existence and configuration of any intermediary devices 119. This topology requires special techniques to discover, and is subject to change. Second, the public addresses that may be used to access the gateway 102, even if available, are usually not static, and thus may assumed to change from time to time. Similarly, where STUN is used to discover a UDP port usable to access the gateway device 102 via a NAT, the NAT may cause particular port mappings to time out, requiring the gateway 102 to reinitiate port discovery with the STUN server 122. Finally, the device (e.g., device 116, 116A) that attempts to access the internal network 104 via the gateway device 102 may require its own specialized configuration/provisioning in order to access the internal network 104. This provisioning may be dependent both on the particular configuration of the gateway 102, as well as on the particular needs of the devices 116, 116A that are independent of the gateway 102 settings (e.g., configurations needed to connect to the external network 106 when outside the local area 118).

Although setting up IGD for general remote access may be complex, in many cases it is likely that external access to the local network 104 is desired only by the owner of the network for specific purposes, such for accessing by a particular mobile device 116, 116A. Because the mobile device 116, 116A is typically tied to a particular wireless service provider network 126, the service provider could provide some or all of the helper services (e.g., Dynamic DNS 120, STUN 122, relay server 124) in conjunction with access to the provider network 126. In addition, the service provider may leverage the unique coupling between the provider network 126 and the compatible mobile devices 116, 116A to automatically configure the gateway device 102.

In one arrangement, the user configures the gateway device 102 by downloading a configuration 128 to the mobile communications device 116, which may be a cellular phone or other mobile, long-range, wireless communications device. The mobile device 116 downloads the configuration 128 via the wireless provider network 126. The download could be automatic, such as where the mobile device 116 interrogates the gateway device 102 via the local network 104 to discover the services and features of the gateway 102. The results of this discovery could be used to send a request for configuration data from the mobile device 116 via the provider network 126. This type of automatic configuration download can be provided using Open Mobile Alliance Device Management (OMA DM), which allows the provider network 126 to automatically push configurations and updates to user devices 116. More details on OMA DM are provided herein below. The download could be manual, such as in response to the user navigating to a configuration Web page using a browser of the mobile device 116 and downloading the configuration 128.

The configuration 128 may be provided by the service provider or by a third-party provider that is accessible from the provider network 126. Once the mobile device 116 has downloaded the configuration 128, a configuration 128A can be uploaded and applied to the gateway device 102. The uploaded configuration 128A may created by the mobile device 116 based on the contents of the downloaded configuration 128 (e.g., formatting, extraction of relevant data). In other arrangements, both configurations 128, 128A may be substantially the same. The downloaded configuration 128 may also contain data used for configuring the mobile device 116 itself, thereby enabling the mobile device 116 to remotely access local network 104 from external networks 106, 126.

Once the configuration 128A is applied to the gateway device 102, the user may use mobile device 11 6A to access services of the local network 104. For example, the user may be browsing a Web page on the mobile device 116A, and wants to print a Web page to the home printer 112, as represented by path 130. The preconfigured mobile device 116A and gateway 102 allow this transaction to seamlessly and securely take place. The mobile device 116A may be the same or different from the device 116 that initially applied the configuration 128A to the gateway device 102.

The application of the configuration 128A to the gateway device 102 may involve use of provisioning services that are built into the local network protocols (e.g., UPNP). The configuration 128A may include network data, such as addresses of servers such as the Dynamic DNS server 120, STUN server 122, and relay server 124. The configuration 128A may also include authentication that allows the gateway 102 and mobile devices 116, 116A access these services. The configuration 128A may also include designations of services of the internal network 104 that may or may not be accessed via the gateway device 104. For example, the user may wish to allow a printing service offered by the printer 112 and a data storage service offered by the computer 110 to be remotely accessible, but deny remote access to any other service or device on the local network 104.

In the discussion that follows, particular embodiments of the present invention will be described in terms of configuring a UPNP IGD. Those familiar with the applicable art will appreciate that these concepts may be applied to any manner of ad-hoc, peer-to-peer networking arrangement suitable for consumer oriented networks, and are not limited to UPNP. For example, the present invention may also be applicable to other technologies, either alone or in combination, such as X-10, xAP, Jini, Rendezvous, HomeRF, Bluetooth, IrDA, etc. Additionally, a gateway device is only one example of a device that may be configured by a mobile communications infrastructure. In cases where network operators that offer both wireless service and broadband access, it may be advantageous for end users to select the same operator for both subscriptions if the setup of local devices is made easier by selecting a single provider. Therefore, the network provider could automatically provide configurations for all manner of internal and external services and devices, such as media services (e.g., streaming media, download services), user data synchronization between Internet accounts and local devices, coupling between provider services and local devices (e.g., configuring cellular phone rings to be sent to a television or stereo, etc.).

Similarly, in the following discussion, local networks may be configured using the OMA DM a mobile device management infrastructure. However, the present invention is applicable to any type of mobile device configuration management system that may be adapted receive and apply local network configurations to other devices. For example, automatic mobile device configuration using downloadable scripts, executable objects, textual data, or other configuration data may be extended to apply configurations to devices that are independent of the mobile device itself.

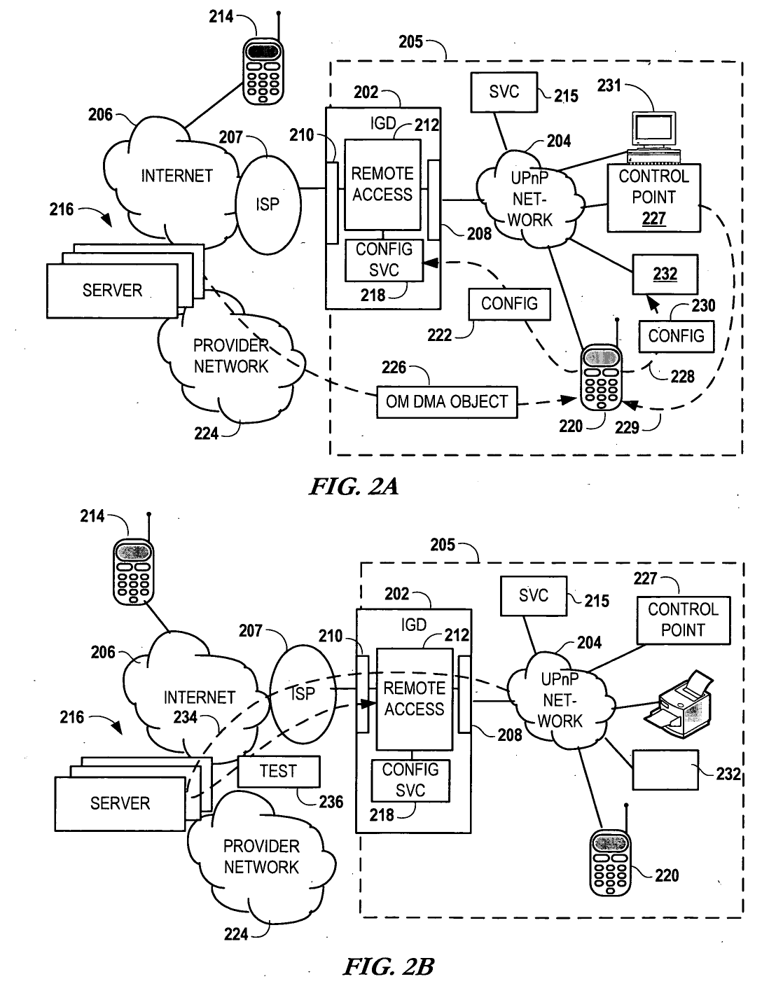

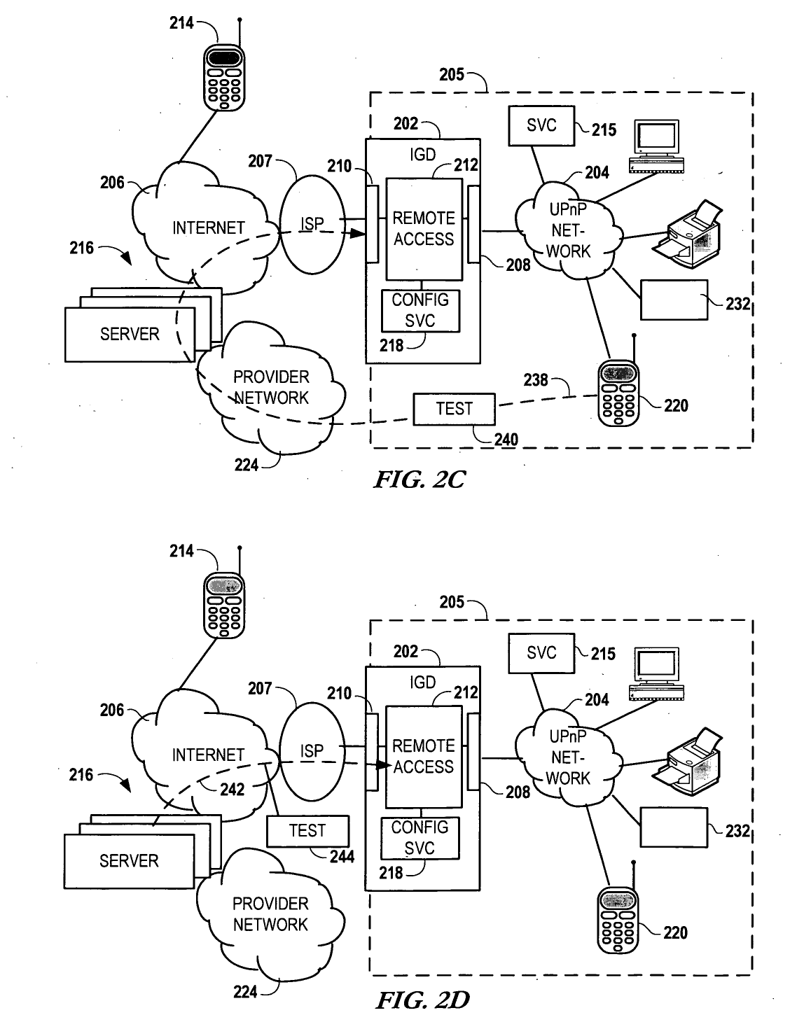

In reference now to FIG. 2A, a block diagram illustrates a more particular example of device configuration according to an embodiment of the present invention. An internal network 204 connects devices in a local environment 205. The internal network 204 may include any hardware and software technologies, including those that provide ad-hoc, peer-to-peer connectivity. In particular, the exemplary internal network 204 includes UPNP support. A gateway device 202 includes the functionality of a UPNP IGD. The IGD 202 may be a standalone gateway device, or may be included as part of another UPNP device, such as a computer or set-top box.

The IGD 202 is coupled to the internal network 204 and an external network 206. In this example, the external network 206 includes the Internet, which is accessed by way of an ISP 207. The IGD 202 may connect to both networks 204, 206 through a single hardware interface. The illustrated IGD 202 however, like many gateway devices, includes two interfaces 208, 210, one for each network 204, 206 respectively. The interfaces 208, 210 may be physically separate devices, or different logical devices running on the same hardware.

The existing UPNP IGD specification provides for limited configuration of the external IGD network interface 210 (e.g., WLAN interface). This configuration allows the IGD 202 to provide external network access for devices on the UPnP network 204. Because UPnP is extensible, a new UPnP IGD remote access service 212 may defined that enables the IGD 202 to provide services (e.g., service 215) of the UPnP network 204 via the Internet 206. Such services 215 could then be accessed access by an Internet-coupled device 214. In order to properly configure the remote access service 212, the IGD 202 (or another UPNP device) may include an IGD remote access configuration service 218. The configuration service 218 is a UPNP service that obtains parameters for configuring the remote access service 212, and applies those configurations to the remote access service 212.

A device on the UPNP network 204, such as a UPNP enabled mobile phone 220, can send a configuration 222 to the IGD 202 via the configuration service 218. The configuration 222 may at least include addressing information, such as IP addresses of one or more servers 216. The servers 216 may be coupled to one or both of the Internet 206 and a mobile services provider network 224. The servers 216 may assist the IGD 202 in providing remote access, for example by providing relay services, STUN services, proxy services, Dynamic DNS services, overlay services, etc. The configuration 222 may also include data such as the authentication data (e.g., data used to authenticate with the helper services 216) and security policies applied to the remote access service 212.

The mobile device 220 may obtain the configuration data 222 in a number of ways. The mobile device 220 may obtain the configuration from an I/O port (e.g., IR port) or memory card (e.g., SIM card). The mobile device 220 may download the configuration 222 directly from the Internet 206 using a browser or other user program. In another arrangement, the mobile device 220 may use OMA Device Management (DM) to receive an OM DMA configuration object 226 that is used to form the configuration settings 222.

The OMA DM -framework allows service providers to manage a large number and wide variety of mobile infrastructure devices, and in particular mobile devices utilized by end users. Generally, management of devices may involve setting and maintaining device configurations, running diagnostics, status reporting, setting and maintaining access rights, installing software, etc. For configuring/provisioning functions, the OMA DM defines protocols that allow configuration and management data to be pushed out to client devices. Version 1.1.2 of OMA DM uses SyncML to encapsulate and apply configurations. SyncML an open, XML-based information synchronization standard that can be applied to data synchronization and device management.

The OMA DM is typically implemented to provision the terminal itself (e.g., device 220). In the context of the present invention, the OMA DM is adapted to provision a device that is separate from the terminal 220, in this case the UPnP gateway 202. The wireless provider network 224 pushes the configuration setting 226 (e.g., a SyncML object) to the mobile terminal 220. The push of the configuration data 226 may occur in response to a user selection and/or based on an automatic determination that a remote access configuration service 218 (or equivalent) exists. The mobile terminal 220 may first query the access configuration service 218 in order to gather information from the IGD 202 that can be used for remote access configuration. For example, information about the IGD vendor, model number, version, WAN interface (e.g., whether its IP address is publicly routable and/or dynamically assigned) may be of use when determining which servers 216 may be involved in enabling the remote access service 212. Alternatively, all service information may be pushed to the mobile device 220, and either the device 220 or the configuration service 218 can determine which helper services 216 are required.

Another mechanism for obtaining the configuration settings 222 involves using direct transfer from a UPnP control point 227 to the mobile device 220, as indicated by path 229. Generally, the UPNP control point 227 is a logical abstraction of control functions that may be implemented in various devices on the UPnP network 204. Typically, a device that implements a control point 227, such as a personal computer 231, has a user interface that may be accessed by the user to control any device on the UPNP network 204 via the control point 227. In one scenario, the user can configure the IGD 202 and/or the remote access module 212 using the computer 231 and/or control point 227, and afterwards the mobile configuration (e.g., object 226) can be transferred 229 to the mobile device 220 using USB, Bluetooth, or the like. In another scenario, the configuration (e.g., object 226) can be first transferred to the mobile device 220 from the control point 231 and/or personal computer 231, and thereafter the mobile device 220 configures the IGD 202, such as via configuration service 218. In either scenario, an OM DMA object (e.g., object 226) can be used to configure one or both of the mobile device 220 and the IGD 202.

For a simple configuration, the OMA DM settings 226 that are sent to one or both of the mobile device 220 and IGD 202 can include a DNS server IP address, Relay server IP address, and authorization information (e.g., authorization method, username, password, shared secret). In situations where the mobile terminal 220 receives the settings 226 before they are applied to the IGD 202 (e.g., pushed from a provider network 224), the relevant data 222 may be automatically extracted and provided to the UPNP configuration service 218. In another arrangement, the user may be prompted to initiate extraction and sending of the relevant data 222 to the configuration service 218. The IGD configuration data 222 may include some or all of the data in the OMA DM object 226. Because UPNP and OMA DM are both XML-based, the configuration service 218 may be able to use the configuration settings 226 in the existing SyncML format. In other arrangements, the mobile terminal 220 may add and/or remove some data (e.g., headers) from the OMA DM object 226 to comply with the UPNP specification of the configuration service 218.

Of course, the configuration of the local devices/services via provider networks 224 is not limited to configuring the IGD 202. The IGD 202 is a natural target for automatic configuration by mobile service providers because of the relative complexity of IGD configuration and likelihood of accessing the IGD 202 via the provider networks 224. However, because mobile service providers may desire to offer a wide variety of services for the mobile device 220, it is also possible that these varied services can be utilized by other devices on the home network 204. This is represented in FIG. 2A by the configuration path 228 and configuration data 230 used to configure generic UPNP device 232. Generally, the generic device 232 may include a configuration service modeled after the configuration service 218 of the IGD 202, and such service may utilize configuration data 230 that is extracted from an OM DMA object (e.g., object 226).

It will also be appreciated that configuration of a remotely accessible service may require configuring both the device providing the service (e.g., device 232) and the gateway device 202 from which the service is remotely accessed. In such a situation, the configuration object may include configuration of multiple devices, including the client (e.g., terminal 220), the server (e.g., device 232) and the gateway (e.g., IGD 202). Because the terminal 220 is a UPNP device itself, it can be adapted to apply configurations to any number of UPNP devices/service based on provisioning data received via a mobile device management service.

Once the remote access service 212 is configured, the IGD 202 may have to register with the external server(s) 216 that assist the gateway 202 in providing services via remote access 212. The required registrations and other transactions between the IGD 202 and the external servers 216 may be defined by way of the configuration 222. After the IGD 202 has been configured and performed any registrations, the remote access module 212 should, in theory, be able to provide one or more of the internal services 215 to an externally coupled device 214. However, the network environment that includes the IGD 202, local network 204, and ISP 207 may vary among different installations. Thus, the IGD 202 may have to test the connectivity and addressing among itself and the external servers 216 in case there are NAT or other devices in-between.

The existence of a NAT firewall may be determined by various protocols such as STUN, which is described in more detail above. The remote access module 212 may also query configurations of the IGD 202 to determine if the IGD 202 itself is acting as a NAT. If a NAT/firewall is detected, some address mapping may be required in order to make the IGD external interface 210 publicly accessible. Other network configuration parameters, such as existence of proxies and Quality of Service (QoS) discovery and allocation, may also be required depending on the requested service.

After configuration and/or registration, testing may be required to test the interactions between the IGD 202 and the servers 216 whose addresses are provided via OMA DM settings 226. In reference now to FIGS. 2B-D, block diagrams illustrate testing scenarios according to embodiments of the invention, wherein the same reference characters are used to describe elements corresponding to elements described in FIG. 2A. This testing may be used to verify the connectivity and fix address mapping that would take place if, for example, NAT or firewalls are located between the IGD 202 and the servers 216. These protocols may include existing NAT traversal protocols such as TURN, STUN, etc., or may include proprietary protocols that send some IP packets from the IGD 202 to the server 216 (e.g., proxy or relay server) to check if there is any addressing mapping. This testing protocol may also be used to ensure that the QoS is guaranteed according to the service requested by the user and provided by the operator. The testing protocol can be part of IGD 202 functionality that uses existing protocols STUN, TURN, etc., or the testing can use a proprietary protocol integrated in the IGD 202, home gateway, or any other device on the local network 204.

FIG. 2B illustrates an example of testing the IGD configuration via a component of the local network 204. Generally, any device on the local network 204 may initiate a “loopback” connection to external interface 210 of the IGD 202 via the Internet 206 and other intermediary servers 216. This test scenario is represented by path 234 and test data 236. The test data 236 may be particular to the service 215 that is being externally provided via the IGD 202. For example, if the service 215 was a personal contacts database, the test data 236 may include data needed to perform a contact lookup. The test path 234 and data 236 may also include generic network testing protocols, such as ping, traceroute, SNMP, ICMP, etc. These protocols may be used before any service-specific tests are performed, in order to test external network paths up to the IGD 202. Finally,-the path 234 and test data 236 may involve providing to the IGD 202 specific data, procedures, and protocols required of the helper services 216.

FIG. 2C illustrates an alternate testing scenario using the mobile terminal 220 in the local environment 205 to perform the test. The mobile terminal 220 may be the same device that configured the IGD 202, and the testing procedures may be provided as part of the IGD/terminal provisioning data provided with the OMA DM object (e.g., object 226 in FIG. 2A). As represented by test path 238 and test data 240, the terminal 220 would independently access the service by way of the provider network 224, servers 216, Internet 206, ISP 207, and/or IGD 202.

FIG. 2D illustrates an alternate testing scenario using one or more servers 216 to perform the test. For example, a server 216 may be configured to emulate an Internet coupled device (e.g., device 214) in order to test the IGD configuration, as represented by test path 242 and test data 244. The server 216 may be triggered to perform the test based on registration of services by the IGD 202, or some other event. Other events may include independent signals sent to the server 216 by the mobile device 220, IGD 202, or any other entity of the local network 204.

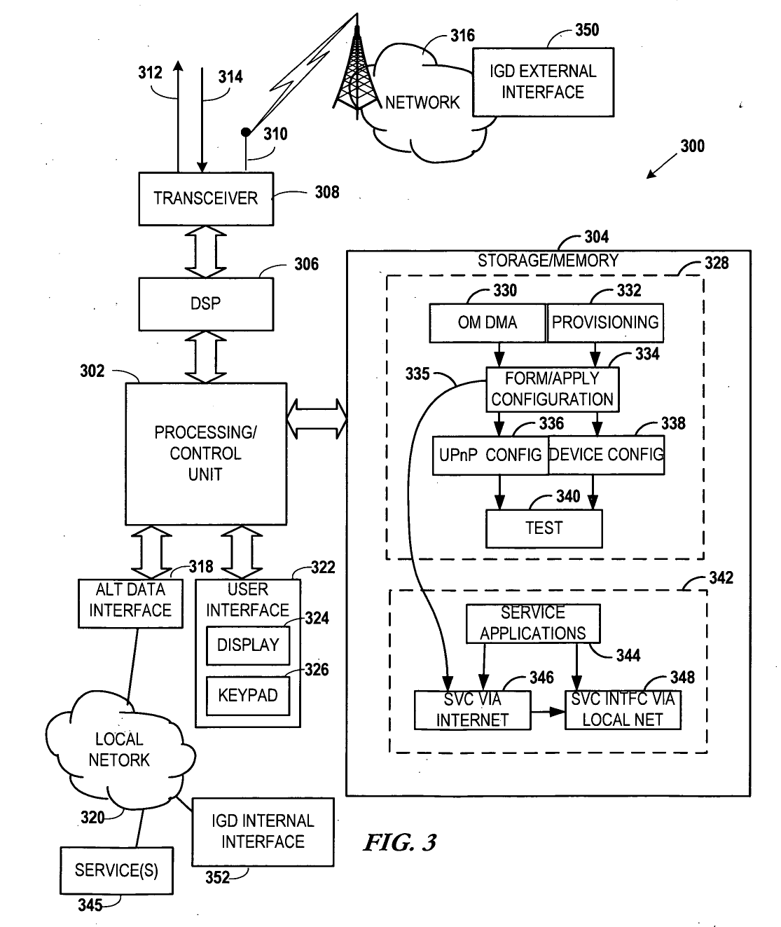

Many types of apparatuses may be able participate in configuration of local networks via mobile service providers as described herein. Mobile devices are particularly useful in this role. In reference now to FIG. 3, an example is illustrated of a representative mobile computing arrangement 300 capable of carrying out operations in accordance with embodiments of the invention. Those skilled in the art will appreciate that the exemplary mobile computing arrangement 300 is merely representative of general functions that may be associated with such mobile devices, and also that landline computing systems similarly include computing circuitry to perform such operations.

The processing unit 302 controls the basic functions of the arrangement 300. Those functions associated may be included as instructions stored in a program storage/memory 304. In one embodiment of the invention, the program modules associated with the storage/memory 304 are stored in non-volatile electrically-erasable, programmable read-only memory (EEPROM), flash read-only memory (ROM), hard-drive, etc. so that the information is not lost upon power down of the mobile terminal. The relevant software for carrying out conventional mobile terminal operations and operations in accordance with the present invention may also be transmitted to the mobile computing arrangement 300 via data signals, such as being downloaded electronically via one or more networks, such as the Internet and an intermediate wireless network(s).

The mobile computing arrangement 300 includes hardware and software components coupled to the processing/control unit 302 for performing network data exchanges. The mobile computing arrangement 300 may include multiple network interfaces for maintaining any combination of wired or wireless data connections. In particular, the illustrated mobile computing arrangement 300 includes wireless data transmission circuitry for performing network data exchanges.

This wireless circuitry includes a digital signal processor (DSP) 306 employed to perform a variety of functions, including analog-to-digital (A/D) conversion, digital-to-analog (D/A) conversion, speech coding/decoding, encryption/decryption, error detection and correction, bit stream translation, filtering, etc. A transceiver 308, generally coupled to an antenna 310, transmits the outgoing radio signals 312 and receives the incoming radio signals 314 associated with the wireless device.

The incoming and outgoing radio signals 312, 314 to communicate with a mobile service provider network 316. The network 316 may include any voice and data communications infrastructure known in the art, including CDMA, W-CDMA, GSM, EDGE, etc. The network 316 typically provides access to traditional landline data infrastructures, including IP networks such as the Internet. The mobile computing arrangement 300 also includes an alternate network/data interface 318 capable of accessing a local network 320. The alternate data interface 318 may incorporate combinations of I/o and network standards such as USB, Bluetooth, Ethernet, 802.11 Wi-Fi, IRDA, etc. The local network 320 may include any manner of data transfer technology. In some embodiments discussed herein, the network 320 is capable of supporting ad-hoc, peer-to-peer data exchanges, exemplified by UPnP.

The processor 302 is also coupled to user-interface elements 322 associated with the mobile terminal. The user-interface 322 of the mobile terminal may include, for example, a display 324 such as a liquid crystal display. Other user-interface mechanisms may be included in the interface 322, such as keypads 326, speakers, microphones, voice commands, switches, touch pad/screen, graphical user interface using a pointing device, trackball, joystick, etc. These and other user-interface components are coupled to the processor 302 as is known in the art.

The program storage/memory 304 typically includes operating systems for carrying out functions and applications associated with functions on the mobile computing arrangement 300. The program storage 304 may include one or more of read-only memory (ROM), flash ROM, programmable and/or erasable ROM, random access memory (RAM), subscriber interface module (SIM), wireless interface module (WIM), smart card, hard drive, or other removable memory device. The storage/memory 304 of the mobile computing arrangement 300 may also include software modules for performing functions according to embodiments of the present invention.

In particular, the program storage/memory 304 may include configuration modules 328 that enable the computing arrangement 300 to configure devices on the local network 320. Typically, the configuration modules 328 include modules capable of receiving provisioning data, such as an OM DM provisioning module 330 or a generic provisioning module 332. These provisioning modules 330, 332 are generally capable of receiving pre-selected and formatted data provided by one or more service providers associated with the mobile networks 316. The OMA DM provisioning module 330 allows a service provider to manage configurations by automatically pushing configuration/provisioning to the mobile arrangement 300. The generic provisioning module 332 may include the ability to obtain provisioning data using network operator-controlled or user-controlled configuration management. This generic configuration management may involve the use of a browser (e.g., be configured as a Web object or browser plug-in) and/or by using standard or proprietary software/protocols (e.g., Java objects). Device configurations received by the provisioning modules 330, 332 can be input to a transformation module 334.

The transformation module 334 receives data that may be in the form of a local device configuration (e.g., OMA DM SyncML object) and transforms the data in order to make it compatible with the configuration interface of the target device (e.g., a UPNP IGD). The transformation module 334 may also extract local device configuration data associated with the target service, as indicated by path 335. Once the external device configuration is extracted, the transformation module 334 can apply the configuration through one or more configuration interfaces, represented by a UPnP configuration interface 336 and a generic device configuration interface 338. The generic configuration interface 338 may be an extensible interface suitable for proprietary standards, such as non-UPnP interfaces provided by consumer electronics manufacturers. The configuration modules 328 may also be arranged to trigger a test module 340 after configurations are applied by configuration interfaces 336, 338. The test module 340 may test, for example, end-to-end network connectivity, QoS, service-specific functionality, etc.

After the external device and/or local devices have been configured, one or more application modules 342 can take advantage of services 345 of the local network 320. When the computing arrangement 300 is proximate to the local network, a service application 344 can use a local service interface 348 to reach and utilize the service 345. For example, the local service interface 348 may be a UPnP interface capable of interacting with UPNP enabled devices via the alternate interface 318. When the computing arrangement 300 is located outside of the local network 320, a remote access module 346 may be used access the service 345.

Generally, the remote access module 346 may handle traversal of public networks 316 and service elements that enable the arrangement 300 to reach the local network 320. In the illustrated arrangement, the remote access module 346 may reach the local network 320 via an external IGD interface 350 coupled to a public network 316. The IGD device is also coupled to the local network 320 via an internal interface 352. In one embodiment described herein, the configuration modules 328 are used to automatically configure the IGD external interface 350 by applying a UPNP configuration via the internal network interface 352 of the IGD.

The mobile computing arrangement 300 of FIG. 3 is provided as a representative example of a computing environment in which the principles of the present invention may be applied. From the description provided herein, those skilled in the art will appreciate that the present invention is equally applicable in a variety of other currently known and future mobile and landline computing environments. For example, desktop computing devices similarly include a processor, memory, a user interface, and data communication circuitry. Thus, the present invention is applicable in any known computing structure where data may be communicated via a network.

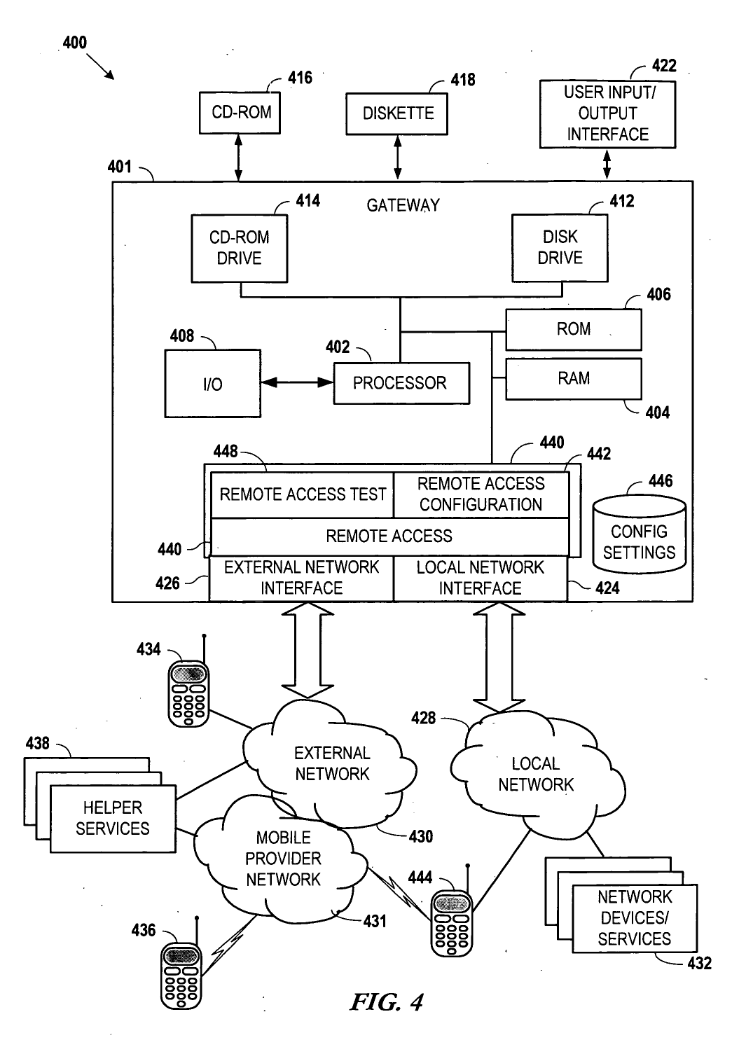

The mobile computing arrangement 300 may be used to configure any local network device using settings provided by a network operator. One type of local network device that may benefit from network provider configuration is a gateway device. Gateway devices provide a link between the home computing/automation environment and the public data networks, the latter being made accessible by service providers. Therefore is desirable for such providers to expand the use of the mobile networks by allowing remote access to home environments via an automatically configured gateway. In reference now to FIG. 4, a block diagram illustrates example gateway 400 according to an embodiment of the invention. The gateway 400 includes a computing arrangement 401. The computing arrangement 401 may include custom or general-purpose electronic components. The computing arrangement 401 includes a central processor (CPU) 402 that may be coupled to random access memory (RAM) 404 and/or read-only memory (ROM) 406. The ROM 406 may include various types of storage media, such as programmable ROM (PROM), erasable PROM (EPROM), etc. The processor 402 may communicate with other internal and external components through input/output (I/O) circuitry 408. The processor 402 carries out a variety of functions as is known in the art, as dictated by software and/or firmware instructions.

The computing arrangement 401 may include one or more data storage devices, including hard and floppy disk drives 412, CD-ROM drives 414, and other hardware capable of reading and/or storing information such as DVD, etc. In one embodiment, software for carrying out the operations in accordance with the present invention may be stored and distributed on a CD-ROM 416, diskette 418 or other form of media capable of portably storing information. These storage media may be inserted into, and read by, devices such as the CD-ROM drive 414, the disk drive 412, etc. The software may also be transmitted to computing arrangement 401 via data signals, such as being downloaded electronically via a network, such as the Internet. The computing arrangement 401 may be coupled to a user input/output interface 422 for user interaction. The user input/output interface 422 may include apparatus such as a mouse, keyboard, microphone, touch pad, touch screen, voice-recognition system, monitor, LED display, LCD display, etc.

The computing arrangement 401 may be coupled to other computing devices via networks. In particular, the computing arrangement includes network interfaces 424, 426 capable of interacting with respective local “home” networks 428 and external “public” networks 430, 431. The network interfaces 424, 426 may include a combination of hardware and software components, including media access circuitry, drivers, programs, and protocol modules. Ultimately, the computing arrangement 401 may be configured to allow local network services 432 to be accessed by devices 434, 436 coupled to the external networks 430, 431. Helper services 438 of the external networks 430, 431 may assist the arrangement 401 in providing these services. The helper services 438 may include STUN and TURN services for breaking through NAT firewalls, and Dynamic DNS services for dealing with dynamic address allocation of the external interface 426.

The computing arrangement 401 includes processor executable instructions 440 for carrying out tasks of the computing arrangement 401. These instructions 440 may include a remote access module 440 capable of providing access to local services 432 via the external networks 430, 431. The remote access module 440 may interact with helper services 438 of the external networks 430, 431 in order to provide such services even though the apparatus 401 includes or operates behind NAT firewalls, and/or the external network interface 426 is dynamically addressed. The remote access module 440 may be provided as a UPNP configurable service that includes/interacts with a configuration interface module 442 that accepts configurations from an entity (e.g., mobile device 444) on the local network 428. The mobile device 444 may obtain the configuration via a mobile provider network 431 and apply the configuration via the remote access configuration module 442, which may be provided as a UPNP service. The configurations may be stored in a settings database 446 of the gateway arrangement 401. The configurations database 446 may include addresses and authentication data related to the helper services 438. The database 446 may be accessed whenever local network services 432 are to be made remotely available.

The computing arrangement 401 may also include a remote access test module 448 which tests settings of the remote access module 440. The test module 448 may test network connectivity, quality of service, and service-specific functionality of the local services 432. The gateway 400 is only a representative example of network infrastructure hardware that can be used to provide services as described herein. Generally, the functions of the gateway 400 can be distributed over a large number of processing and network elements, and can be integrated with other services, such as service enablers, routers, mobile communications messaging, etc.

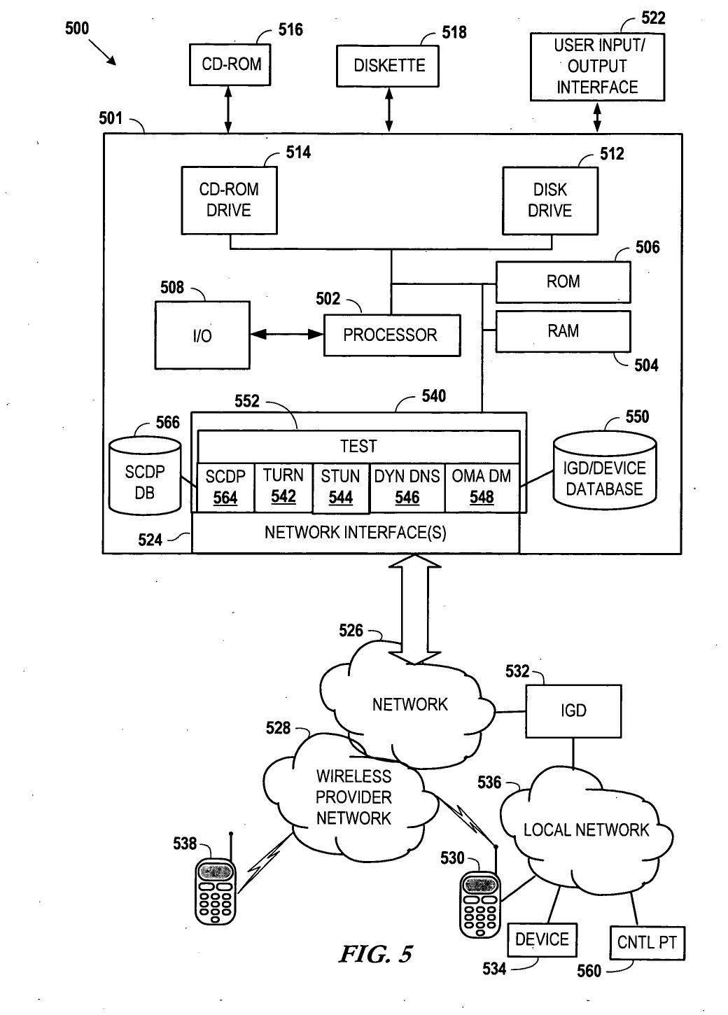

Due to the nature of some home ISP arrangements, the gateway 400 may rely substantially on the helper services 438 to provide remote access. A more detailed example of a helper service element 500 according to an embodiment of the invention is shown in the block diagram of FIG. 5. The service element 500 includes a computing arrangement 501. The computing arrangement 501 may include custom or general-purpose electronic components. The computing arrangement 501 includes a central processor (CPU) 502 that may be coupled to random access memory (RAM) 504 and/or read-only memory (ROM) 506. The ROM 506 may include various types of storage media, such as programmable ROM (PROM), erasable PROM (EPROM), etc. The processor 502 may communicate with other internal and external components through input/output (I/O) circuitry 508. The processor 502 carries out a variety of functions as is known in the art, as dictated by software and/or firmware instructions.

The computing arrangement 501 may include one or more data storage devices, including hard and floppy disk drives 512, CD-ROM drives 514, and other hardware capable of reading and/or storing information such as DVD, etc. In one embodiment, software for carrying out the operations in accordance with the present invention may be stored and distributed on a CD-ROM 516, diskette 518 or other form of media capable of portably storing information. These storage media may be inserted into, and read by, devices such as the CD-ROM drive 514, the disk drive 512, etc. The software may also be transmitted to computing arrangement 501 via data signals, such as being downloaded electronically via a network, such as the Internet. The computing arrangement 501 may be coupled to a user input/output interface 522 for user interaction. The user input/output interface 522 may include apparatus such as a mouse, keyboard, microphone, touch pad, touch screen, voice-recognition system, monitor, LED display, LCD display, etc.

The computing arrangement 501 may be coupled to other computing devices via networks. In particular, the computing arrangement includes a network interface 524, capable of interacting with one or more “public” networks 526, 528. The network interface 524 may include a combination of hardware and software components, including media access circuitry, drivers, programs, and protocol modules. Ultimately, the computing arrangement 501 may be configured to provide a device configuration to a mobile terminal 530, an IGD 532, or any other device 534 that is coupled to a local network 536. The device configuration may be provided directly from the arrangement 501 to the target devices 530, 532, 534, or by way of an intermediary, such as the mobile terminal 530. The IGD 532 provides devices of the local network 536 access to the public networks 526, 528, and may also be configured to provide services of the local network 536 to a device 538 that is outside the local network 536.

The computing arrangement 501 includes processor executable instructions 540 for carrying out tasks of the computing arrangement 501. These instructions 540 may include a TURN relay services module 542 capable of providing relaying service requests originating from the public networks 526, 528 to an external interface of the IGD 532. A STUN module 544 may provide responses to specially crafted UPD packets originating from the IGD 532 that enable the IGD 532 to determine the existence and classification of any NAT firewalls between the IGD 532 and a public network 526. A Dynamic DNS module 546 may provide a mapping between a hostname and a dynamically allocated IP address used on a public interface of the IGD 532.

The helper modules 542, 544, 546 may be used in any combination to allow an IGD 532 to provide remote access to services of the local network 536. An OMA DM module 548 can be used to configure the IGD 532 (or other device 534) of the local network 536 via a locally coupled mobile terminal 530. The OMA DM module 548 may also configure the terminal 530 to access these services at the same time the local network devices 532, 534 are being configured. The OMA DM module 548 may access a device database 550 that includes parameters for various known local devices/services 532, 534 as well as parameters for various mobile terminals 530, 538. In order to test various applications of configurations via the OMA DM module 548, the computing arrangement may include a test module 552. The test module may interact with any of the helper services modules 542, 544, 546 to test configurations applied to a local network device 532, 534. For example, the test module 552 may be configured to emulate a remotely coupled mobile device 538 in order to test remote access of a local network service via the IGD 532.

In an alternate arrangement, remote configuration may be applied to the IGD 532 and mobile devices 530, 538 by way of a UPnP control point 560 coupled to the local network 536. The control point 560 may send a request to the service element 500 to configure the IGD 532 and remote access devices 530, 538. Because these devices 532, 530, 538 may be UPnP capable, the configurations may be configured as a UPnP service description or Service Control Protocol Description (SCPD). The SCPD defines the protocol between a UPnP control point 560 (e.g., mobile device or PC) and a UPnP Device (e.g., an IGD 532 or other device 534). The request sent by the control point 560 is processed by an SCPD module 564 of the computing arrangement 501.

The SCPD module 564 determines the type and quantities of devices on the local network 536 that require configuration. Much like the OMA DM module 538, the SCPD module 564 may form a configuration that includes various helpers services 542, 544, 546 that may be utilized by the IGD 532 and mobile devices 530, 538 to provide remote access to services of the local network 536. However, the SCPD module 564 may utilize a different database, as represented by the SCPD database 566, in order to determine the correct configurations based on UPnP SCPD descriptors (or similar configuration mechanisms used in the UPnP network 536). The SCPD module 564 returns such configurations to the control point device 560, which then proceeds to configure the IGD 532, mobile devices 530, 538, an any other devices (e.g., device 534) that may participate in remote access of local services.

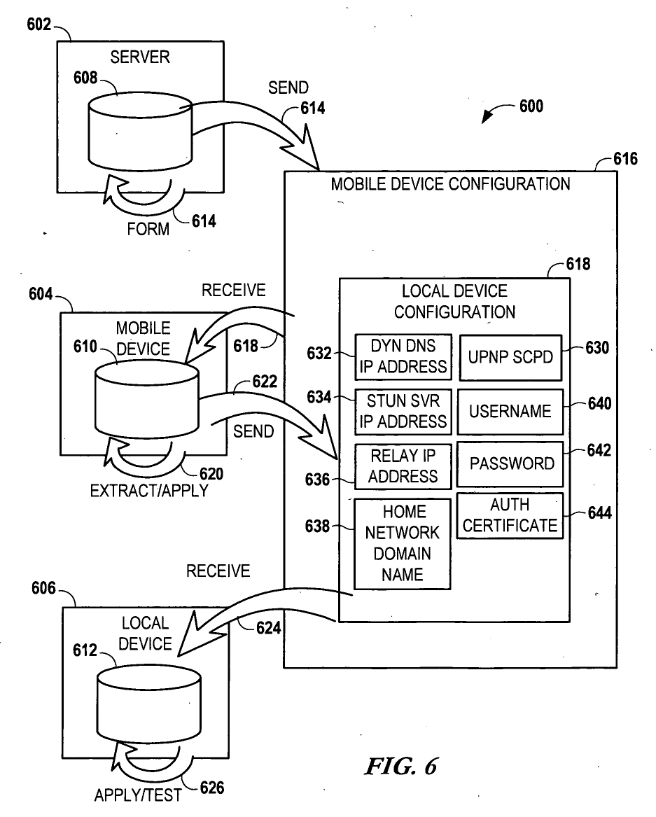

As may be evident from the preceding figures, a device configuration according to embodiments of the invention may involve exchanges of data between multiple network elements. In reference now to FIG. 6, a block diagram illustrates an example data structure 600 usable in configuring local devices according to an embodiment of the invention. Generally, the data structure 600 is utilized, at least in part, by three processing elements: an infrastructure server 602, a mobile device 604, and a local device 606 (e.g., a gateway device). Each of the devices 602, 604, 606 include respective data storage 608, 610, 612, which may include any manner of volatile and non-volatile storage.

The data structure 600 is first generated 614 by the server 602, typically in response to a request from the mobile device 604. The data structure 600 includes a mobile device configuration portion 616 that is tailored for the particular mobile device 604. Embedded within the mobile device configuration 616 is a local device configuration 618 that is particular to the local network device 606 of interest. The server 602 will generally have knowledge of the characteristics of both devices 604, 606. This knowledge may be obtained from an external database (e.g., database 550 in FIG. 5) or may be obtained from the devices 604, 606 themselves.

The server 602 forms the data structure 600 and sends 614 it via a mobile service provider network, where it is received 618 by the mobile device 604. The mobile device 604 may extract 620 both the mobile-specific portions and local-device-specific portions 618 of the mobile device configuration 616. The mobile specific portions of the configuration 616 (if any) are applied 620 to the mobile device 604, and the local device specific portion 618 is sent 622 to the local device 606 (e.g., via a UPnP configuration interface). Upon receipt 624 of the local configuration 618, the local device 606 will apply and/or test 626 the configuration 618.

The local configuration 618 includes data needed to allow the local device 606 (e.g., gateway) to provide remote access. If the device 606 is a UPnP device, then the local configuration 618 may include a UPNP service description or Service Control Protocol Description (SCPD) 630. In this example, the specific information required to configure the remote access in the local device 612 is included in the SCPD 630. Remote access configuration data in the SCPD 630 (or other data structure within the configuration 618) may include any combination of a Dynamic DNS server IP address 632, STUN server IP address 634, a relay server IP address 636, a home network domain name 638, username 640, password 642, and authentication certificates 644.

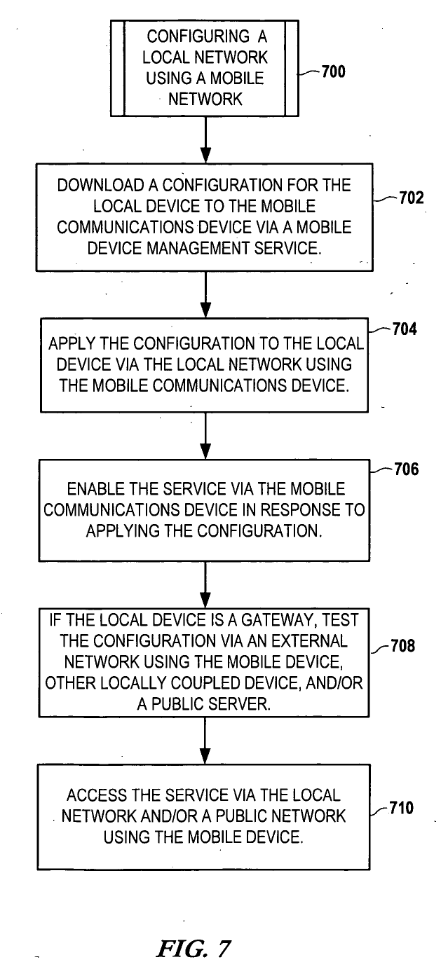

In reference now to FIG. 7, a flowchart illustrates a procedure 700 for configuring a local network using a mobile network according to an embodiment of the invention. A configuration for a local device (e.g., a device coupled to the local network) is downloaded 702 via a mobile device management service. The configuration is then applied 704 to the local device via the local network using the mobile communications device. The mobile communications device enables 706 the service in response to applying the configuration, such as by successful application of the configuration and/or invoking a function of the local device. If the local device is a gateway, a test 708 of the configuration may be conducted via an external network using the mobile device, other locally coupled device, and/or a public server. After successful configuration, the mobile device may access 710 the service, either locally or via a public network, assuming a gateway device has been configured to provide the service to the public network.

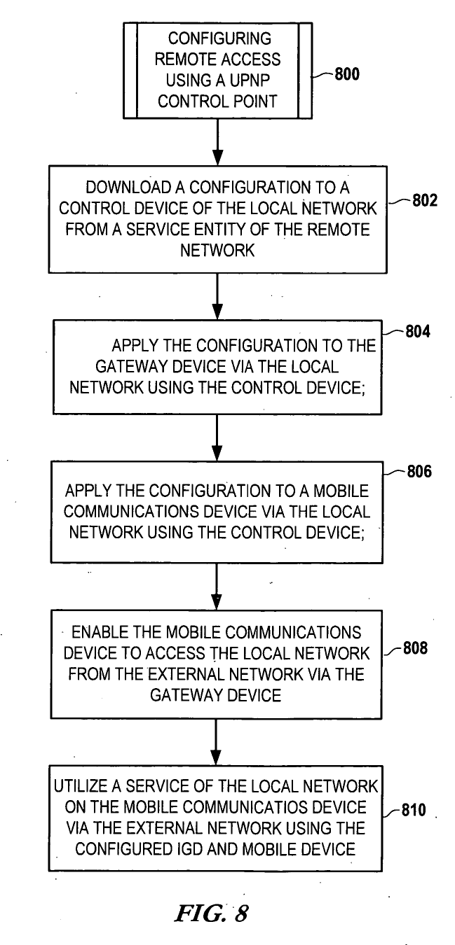

In reference now to FIG. 8, a flowchart illustrates a procedure 800 for configuring remote access using a UPnP control point according to an embodiment of the invention. In particular, the procedure 800 configures access to a local network from an external network via a gateway device that couples the local network with the external network. A configuration is downloaded 802 to a control device of the local network from a service entity of the remote network. For example, the SCPD module 564 of FIG. 5 may provide such a configuration for UPnP devices. The configuration is then applied 804, 806 to the gateway device and a mobile communications device via the local network. The mobile communications device is typically capable of being coupled to both the local network (e.g., via UPNP) and the external network (e.g., via a cellular service provider). Thereafter, the mobile communications device is enabled 808 to access the local network from the external network via the gateway device in response to applying the configuration to the mobile communications device and the gateway device. A service of the local network can then be utilized 810 via the external network based on the configuration of the devices.

The foregoing description of the exemplary embodiments of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined by the claims appended hereto.

What is claimed is:

1. A method comprising:
downloading, via a mobile device management service of a wireless provider network, a configuration for a local network device;
applying the configuration to the device via the local network; and
enabling the service via a mobile communications device in response to applying the configuration.

2. The method of claim 1, wherein downloading the configuration comprises downloading the configuration to the mobile communications device via the mobile device management service of the wireless provider network.

3. The method of claim 2, wherein applying the configuration comprises applying the configuration via the mobile communications device.

4. The method of claim 1, wherein the device comprises a gateway device that couples the local network with an external network, and wherein enabling the service via the mobile communications device comprises enabling the gateway to provide the service via the external network.

5. The method of claim 4, further comprising testing the accessibility from the external network of the service via the gateway device from within the internal network.

6. The method of claim 4, wherein enabling the gateway device comprises configuring the gateway device to utilize a network address translation traversal protocol.

7. The method of claim 4, wherein enabling the gateway device comprises registering the gateway device with a network entity of the external network that assists the gateway device in receiving service requests via the external network.

8. The method of claim 7, wherein registering the gateway device with a network entity of the external network comprises registering the gateway device with a relay server that receives the service requests via the external network on behalf of the gateway device and relays the requests to the gateway device.

9. The method of claim 7, wherein registering the gateway device with a network entity of the external network comprises registering the gateway device with a dynamic domain name service.

10. The method of claim 1, wherein downloading the configuration via the mobile device management service comprising downloading the configuration via an Open Mobile Alliance Device Management protocol.

11. The method of claim 10, wherein applying the-configuration to the device via the mobile communications device comprises applying the settings via a Universal Plug and Play service of the gateway device.

12. The method of claim 1, wherein applying the configuration to the device comprises applying the settings via a Universal Plug and Play service of the gateway device.

13. A method comprising:
downloading a configuration to a control device of a local network from a service entity of a remote network;
applying the configuration, via the local network using the control device, to a gateway device that couples the local network with the remote network;
applying the configuration to a mobile communications device via the local network using the control device; and
enabling the mobile communications device to access the local network from the external network via the gateway device in response to applying the configuration to the mobile communications device and the gateway device.

14. The method of claim 13, wherein the mobile communications device to access the local network from the external network via the gateway device comprises registering the gateway device with a network entity of the external network that assists the gateway device in receiving service requests via the external network.

15. The method of claim 14, wherein registering the gateway device with a network entity of the external network comprises registering the gateway device with one or more of
a) a relay server that receives the service requests via the external network on behalf of the gateway device and relays the requests to the gateway device,
b) a dynamic domain name service, and
c) a network address translator traversal service that allows the gateway device to determine a publicly accessible network address usable by the gateway device for receiving requests.

16. An apparatus comprising:
one or more network interfaces capable of communicating via a wireless provider network and a local network;
a processor coupled to the one or more network interfaces; and
a memory coupled to the processor, the memory including instructions that cause the processor to,
download a configuration for a device of the local network via a mobile device management service of the wireless provider network;
apply the configuration to the device via the local network;
enable a service of the device in response to applying the configuration;
access the service via the local network.

17. The apparatus of claim 16, wherein the device of the local network comprises a gateway device that couples the local network to an external network, and wherein the gateway device provides the service on behalf of a service element of the local network.

18. The apparatus of claim 17, wherein the instructions further cause the processor to test the accessibility of the service from the gateway device via the external network using a connection to the wireless provider network.

19. The apparatus of claim 17, wherein the instructions further cause the processor to, based on the configuration received via the mobile device management service, configure the apparatus to access the service from the gateway device via the external network.

20. The apparatus of claim 16, wherein the configuration comprises an Open Mobile Alliance Device Management configuration.

21. The apparatus of claim 16, wherein the instructions cause the processor to apply the configuration to the device via a Universal Plug and Play service of the device.

22. The apparatus of claim 16, wherein the instructions further cause the processor to, based on the configuration received via the mobile device management service, configure the apparatus to access the service via the local network.

23. A gateway device comprising:
a first network interface capable of communicating via a local network;
a second network interface capable of communicating via an external network;
a processor coupled to the first and second network interfaces; and
a memory coupled to the processor, the memory including a remote access module capable of providing access to a service of the local network via the external network, the memory further including instructions that cause the processor to,
receive a configuration via a mobile device coupled to the local network, the configuration originating from a mobile device management service accessible by the mobile device;
apply the configuration to the remote access module; and
make the service accessible to the external network via the second network interface in response to applying the configuration to the remote access module.

24. The gateway device of claim 23, wherein the instructions cause the processor to make the service accessible to the external network by utilizing a network address translation traversal protocol.

25. The gateway device of claim 23, wherein the instructions further cause the processor to register the gateway device with a network entity of the external network that assists the gateway device in receiving service requests.

26. The gateway device of claim 25, wherein the network entity of the external network comprises one or more of
a) a relay server that receives the service requests via the external network on behalf of the gateway device and relays the requests to the gateway device, and
b) a dynamic domain name service.

27. A server arrangement comprising:
a network interface capable of communicating via a public network and a wireless provider network;
a processor coupled to the network interface; and
a memory coupled to the processor, the memory including a mobile device management service module and instructions that cause the processor to,
receive a request from a mobile device via the mobile device management service module, the request including parameters of a service device of a local network that is capable of being accessed by the mobile device via the local network;
forming a configuration of the service device based on the parameters;
sending a configuration of the device to the mobile device via the mobile device management service module for purposes of facilitating configuration of the service device by the mobile device via the local network.

28. The server arrangement of claim 27, wherein the service device of the local network comprises a gateway device coupled to the local network and the public network, and wherein the gateway device provides a service to the mobile device via the public network on behalf of a service element of the local network.

29. The server arrangement of claim 28, further comprising a network helper service module capable of assisting the gateway device in providing services accessible via the public network.

30. The server arrangement of claim 29, wherein the helper service module comprises one or more of
a) a relay service that accepts connection requests on behalf of the gateway device and relays the requests to the gateway device,
b) a network address translation traversal service that allows the gateway device to determine a publicly accessible network address usable by the gateway device for receiving requests, and
c) a dynamic domain name service that maps a hostname to a dynamic address of the external network associated with the gateway device.

31. A server arrangement comprising:
a network interface capable of communicating via a public network;
a processor coupled to the network interface; and
a memory coupled to the processor, the memory including instructions that cause the processor to,
receive a request from a control device coupled to a local network, the request including a request for a configuration of a gateway device that couples the local network to the public network and a mobile device that is capable of being coupled to the local network and the public network;
forming the configuration based on parameters of the gateway device and mobile device contained in the request;
sending the configuration to the control device for purposes of facilitating configuration of the gateway device and the mobile device to enable the mobile device to access the local network from the public network via the gateway device.

32. The server arrangement of claim 31, further comprising a network helper service module capable of assisting the gateway device in providing services of the local network that are made accessible to the mobile device via the public network based on the configuration applied to the gateway device and the mobile device.

33. The server arrangement of claim 32, wherein the helper service module comprises one or more of
a) a relay service that accepts connection requests on behalf of the gateway device and relays the requests to the gateway device,
b) a network address translation traversal service that allows the gateway device to determine a publicly accessible network address usable by the gateway device for receiving requests, and
c) a dynamic domain name service that maps a hostname to a dynamic address of the external network associated with the gateway device.

34. A computer-readable medium having instructions stored thereon which are executable by a mobile terminal capable of being coupled to a local network and a wireless provider network for performing steps comprising:
downloading a configuration for a device of the local network via a mobile device management service of the wireless provider network;
applying the configuration to the device via the local network;
enabling the service at the device via the local network; and
accessing the service via the local network.
